(19) United States
(12) Patent Application Publication
(10) Pub. No.: US 2017/0062165 A1
(43) Pub. Date: Mar. 2, 2017

(54) DEVICE WITH SEPARATION LIMITING STANDOFF

(71) Applicant: Innovative Micro Technology, Goleta, CA (US)

(72) Inventors: Christopher S. GUDEMAN, Lompoc, CA (US); Paul J. RUBEL, Santa Barbara, CA (US)

(73) Assignee: Innovative Micro Technology, Goleta, CA (US)

(21) Appl. No.: 15/232,871

(22) Filed: Aug. 10, 2016

Related U.S. Application Data
(60) Provisional application No. 62/210,331, filed on Aug. 26, 2015.

(51) Int. Cl. H01H 59/00

(52) U.S. Cl. CPC H01H 59/0009

(57) ABSTRACT

An MEMS device, having two substantially parallel surfaces are separated by an initial distance. At least one of the surfaces includes a raised feature that limits the gap between the surfaces to less than the initial distance when an actuating voltage is applied. In some embodiments, the raised feature limits the gap to about 66% of the initial distance.

### CROSS REFERENCE TO RELATED APPLICATIONS

Not applicable.

### STATEMENT REGARDING FEDERALLY SPONSORED RESEARCH

Not applicable.

### STATEMENT REGARDING MICROFICHE APPENDIX

Not applicable.

### BACKGROUND

This invention is directed to MEMS devices.

The parallel plates of an electrostatically actuated MEMS plate device may be pulled together by a voltage (V) applied across the plates. The displacement of the plates is determined by a balance between the electrostatic force and the restoring force of the springs that support the plates. It is well known that when increasing V, such that the gap between the plates is at or below 66% of the initial (V=0) separation, the plates' relative position becomes unstable, resulting in the runaway acceleration of the plates toward one another and ultimately impact. This impact can be harmful to the MEMS device, causing cold-welding, cracking, material transfer, coining, or embossing, all of which can decrease the reliability of the device.

Three methods have been used to mitigate the effects of runaway at the ⅓ point of electrostatic actuation:
1) Charge control. At constant voltage the electrostatic force increases roughly quadratically as the separation of the plates is reduced, while the restoring spring force increases only linearly. If the voltage across the plates is reduced during approach, the electrostatic force will also be reduced. If this is precisely controlled, the impact energy of the plates can be reduced. The precise control of the charge on the plates is difficult, and has only been demonstrated on devices with integrated CMOS drivers.
2) Waveform Control. Similar to method (1) the charge on the parallel plates in this case is controlled empirically through an arbitrary voltage waveform generator. This provides less precise control compared to (1), but is often easier to implement.
3) Non-linear springs. In this case the mechanics of the spring do not follow a simple Hooke's Law behavior. Generally the non-linearity is cubic and therefore provides too much compensation, which then requires a much higher actuation voltage, which can lead to breakdown or higher costs.

Accordingly, since each of these methods is difficult to implement and/or involves additional cost, a parallel plate MEMS device is needed that does not exhibit the runaway instability.

### SUMMARY

We describe here a device that does not exhibit the runaway instability and thus provides for a much more controlled and gentle impact of the surfaces. The device is described with respect to a particular embodiment, which is a microfabricated (MEMS) plate switch. The plate switch may be initially separated by an initial distance or gap, D1, before actuation forces are applied.

The device may be mechanically constrained to operate within the top ⅓ of its initial distance, D1. The mechanical constraint may be a post or raised feature fabricated on at least one of the surfaces. Because of the mechanical constraints, the surfaces can be made to impact at essential zero velocity. This is done such that no penalty is realized in the loading force of the surfaces when in contact. This also allows for a broad range of flexibility in the applied waveform.

The device may be fabricated with one or more raised features on at least one of the surfaces such that the surfaces interfere when the gap is less than or equal to ⅔ of the gap height. These features may be made using MEMS lithographic techniques, as described below. For this device, the one or more raised features will touch before the runaway condition is reached. Accordingly, the device may include a first plate separated from a second plate by an initial distance, wherein at least one of the first plate and the second plate further comprises a raised feature, wherein the raised feature limits the gap between the surfaces to about 66% of the initial distance when an actuation is applied.

The device may be, for example, a parallel plate MEMS device which is actuated by a force. The actuation force may arise from any of a number of phenomena, including electrostatic, magnetostatic, electromagnetic or piezoelectric effects. In other embodiments, the MEMS device may be at least one of an actuator, a switch and a sensor.

Accordingly, more generally, a device is described which may include a first surface separated from a second surface by an initial distance D1, wherein at least one of the first surface and the second surface further comprises one or more raised features of height D2, wherein the one or more raised features limits a gap between the surfaces to the distance D2, wherein D2<D1, when an actuation is applied. Furthermore, in at least one embodiment, the distance D2 may be about 66% of D1.

These and other features and advantages are described in, or are apparent from, the following detailed description.

### BRIEF DESCRIPTION OF THE DRAWINGS

Various exemplary details are described with reference to the following figures, wherein:

FIG. 1 is a plot showing the separation of a hypothetical device;

FIG. 2 is a schematic diagram of a capacitor on a spring;

FIG. 3 is a schematic diagram of the inventive switch; and

FIG. 4 is a plot of simulation results for the inventive switch; and

FIG. 5 is a cross sectional view of an exemplary MEMS switch device with a separation limiting standoff;

It should be understood that the drawings are not necessarily to scale, and that like numbers may refer to like features.

### DETAILED DESCRIPTION

The device described herein is mechanically constrained to operate within the top ⅓ of the initial gap. The mechanical constraint may be a raised feature fabricated on at least one of the surfaces. The raised feature may have any arbitrary shape, such as a post, a bump, a sphere, a pyramid, a trapezoid, but in any case, the feature has a surface that protrudes beyond the adjacent, relatively flat surface. Furthermore, the raised feature may be one of a plurality of raised features, and the raised feature(s) may be placed uniformly around a plate, or near or at the periphery of the plate, or in a single location, for example. The number and placement of the raised feature(s) will depend on the details of the application and the architecture of the MEMS device.

Because of the mechanical constraint provided by the raised feature, the surfaces can be made to impact at essentially zero velocity. This is done such that no penalty is realized in the loading force of the surfaces when in contact. This also allows for a broad range of flexibility in the applied waveform. One embodiment of the concept is a parallel plate electrostatic MEMS switch. However, It should be understood that the concept may be applied to other sorts of devices and other sorts of actuation mechanisms.

In one exemplary embodiment, the actuation mechanism may be electrostatic, with an attractive force arising between the surfaces as a result of an applied voltage. However, this is but one example, and other actuation mechanisms may be used, including magnetic, magnetostatic, electromagnetic and piezoelectric, for example.

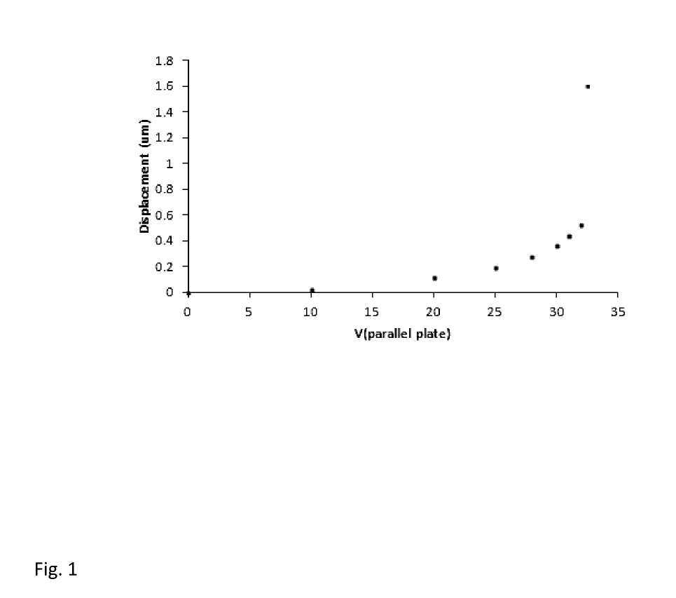

In one embodiment, the device employs a raised feature on one or both of the plates in a parallel-plate electrostatic MEMS device. This feature comes into contact with the opposing plate before the applied voltage can displace the plate more than ⅓ of the V=0 separation. Referring to the FIG. 1, the V=0 separation of this hypothetical device is 1.6 um. If the parallel-plate voltage does not exceed 32V, the plates will not impact one another. At or below this voltage, the plates will undergo a displacement of no more than ˜0.51 um, or ˜⅓ of 1.6 um, and the displacement is a monotonic function of the applied voltage.

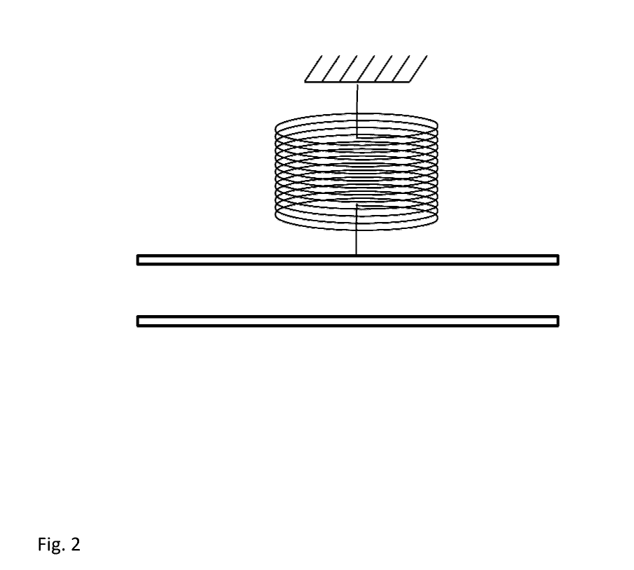

The implementation of this can be explained by considering the “capacitor on a spring” concept. This is shown schematically in FIG. 2.

If the top plate is grounded and a voltage V is applied to the bottom plate, the top plate will move down until the spring force, which pulls up, is equal but opposite to the electrostatic force, which pulls down. Once the top surface moves ⅓ of the gap distance, however, an infinitesimal increase in the applied voltage will cause the top beam to snap down against the bottom surface at high velocity.

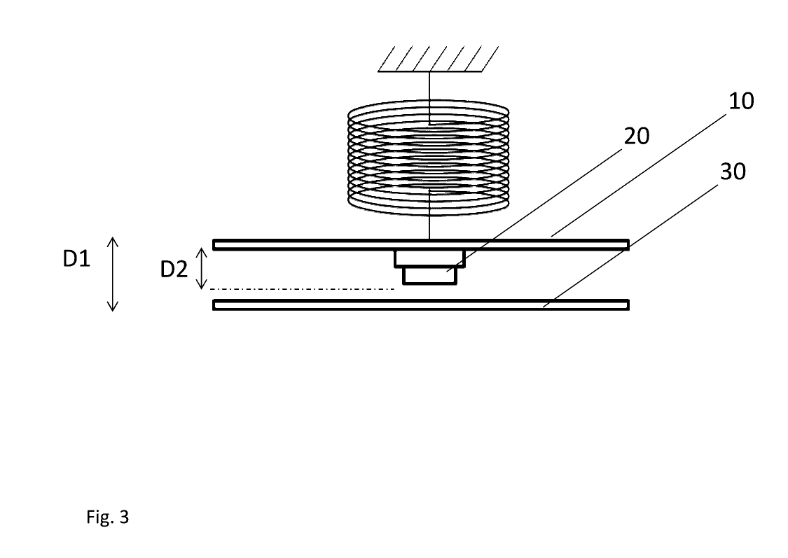

The high velocity runaway condition can be avoided using the configuration shown in FIG. 3. As illustrated in FIG. 3, an upper surface 10 and a lower surface 30 are separated by an initial distance D1. The upper surface 10 has a post 20 of height D2 fabricated thereon. When the actuation voltage is applied from a power supply (not shown) the switch will close to a minimum separation of D2, wherein D2 is less than D1. In some embodiments, D2 is about 66% of D1.

Any number of raised features may be created, each with a height that is greater than or equal to ⅔ of the initial distance. In any case, the raised feature will touch down on the opposite surface before the runaway condition is reached. While in one embodiment, a post is used as the raised feature, it should be understood that any of a number of alternative or arbitrary shapes may be used, as long as the feature is mechanically competent to withstand the forces and define the minimum separation between the surfaces.

Many suitable dielectric materials exist for the raised feature. The raised feature may comprise, for example, an inorganic dielectric layer such as silicon dioxide, silicon nitride, polysilicon, amorphous silicon, spin-on glass (SOG), or a spin coated, temperature tolerant polymer layer such as SU8, polyimide, or benzocyclobutene (BCB). These materials may be formed or deposited in arbitrary shapes using known lithographic techniques.

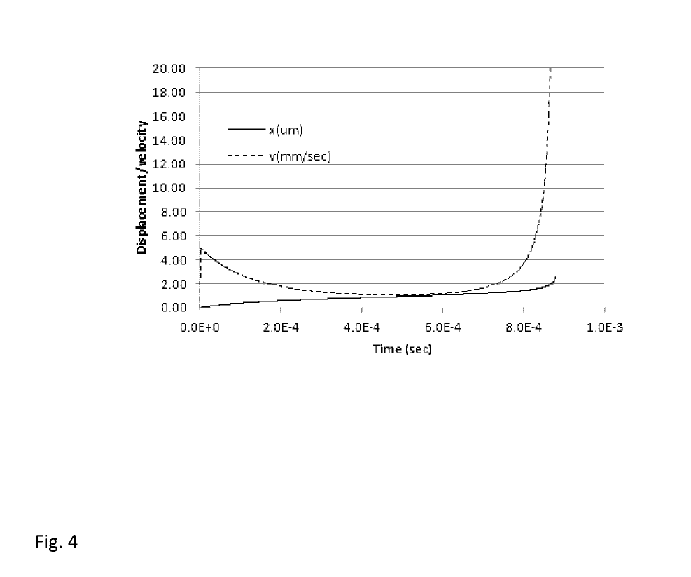

The effect of the raised feature is evident in the plot shown in FIG. 4, which shows simulation results of the displacement (x) and velocity (v) of the surface as a function of time (sec). Here a step function voltage is applied to the bottom surface with the top surface grounded. At the point where raised feature comes into contact (where the top surface has moved 1 um), the velocity of the surface is roughly 1 mm/sec. In the absence of the raised feature the top surface would continue to move until it hits the bottom surface (3 um in this simulation). Here the velocity is >20 mm/sec. Thus, the impact energy in the case without the raised feature is 400× that with the raised feature, thus leading to improved reliability.

The raised feature may be disposed on a surface of an electrostatic plate switch, which delivers an RF input signal to a set of output pads. The switch may have an operating frequency of at least about 1 MHz, such that when the switch is closed, the input signal is capacitively delivered to the output pads. More specifically, the capacitive plate switch may form a nominally closed, capacitive connection when the two plates are separated by the distance D2 and form an nominally open connection when separated by the distance D1, for an RF signal at or above an operating frequency. In the nominally closed position, the input signal is delivered to the output pads; in the nominally open position, it is not. In some embodiments, the operating frequency may be at least about 1 MHz.

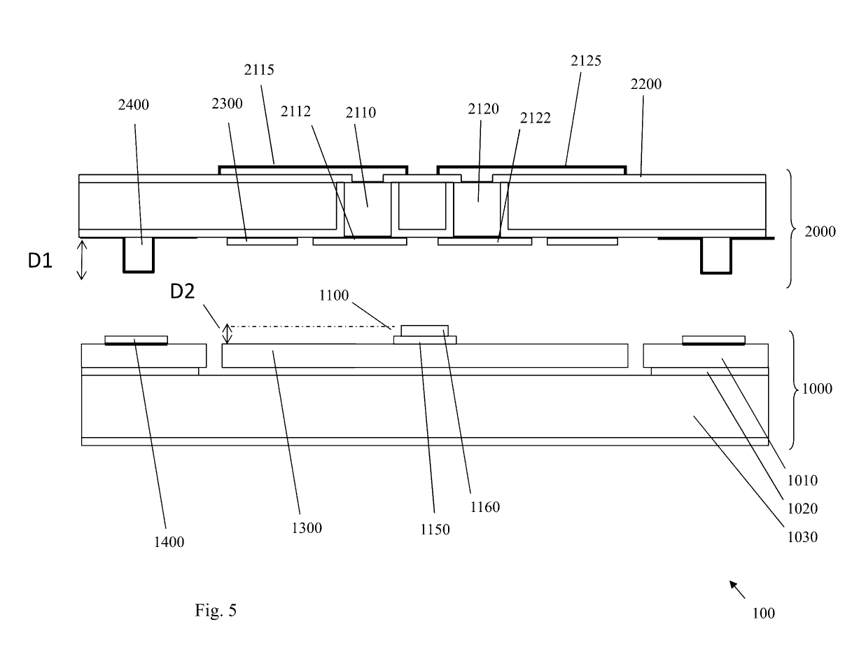

FIG. 5 is a cross sectional view of an embodiment of the MEMS electrostatic switch device 100 with a separation limiting standoff 1100. This embodiment may be fabricated on two substrates, a plate substrate 1000 and a via substrate 2000. The plate substrate 1000 may be an SOI wafer, and the via substrate may be a silicon wafer, for example. The SOI plate substrate 1000 may include a silicon device layer 1010, an insulating layer 1020, and a thicker, silicon handle layer 1030. SOI wafers are well known in the art.

The switch 100 may include a plate 1300 bearing at least one standoff 1100. The standoff 1100 may include an insulating pad 1150 and a mechanically competent separation limiting feature 1160. The plate 1300 may be deformable, meaning that it is sufficiently thin compared to its length or its width to be deflected when a force is applied, and may vibrate in response to an impact. For example, a deformable plate may deflect by at least about 10 nm at its center by a force of about 1 μNewton applied at the center, and sufficiently elastic to support vibration in a plurality of vibrational modes. The deformable plate 1300 may be suspended above the handle layer 1030 of an SOI plate substrate 1000 by four spring beams (not shown in FIG. 5), which are themselves affixed to the silicon handle layer 1030 by anchor points formed from the insulating dielectric layer 1020 of the SOI plate substrate 1000. As used herein, the term “spring beam” should be understood to mean a beam of flexible material affixed to a substrate at a proximal end, and formed in substantially one plane, but configured to move and provide a restoring force in a direction substantially perpendicular to that plane. The deformable plate 1300 may carry at least one conductive shunt bar which operate to close the switch 100, as described below.

Additional details of such a device are disclosed in U.S. Pat. No. 7,893,798 B2, issued Feb. 22, 2011 and assigned to the same assignee. This patent is incorporated by reference in its entirety. Unlike the '798 patent however, there is no electrical shunt bar in the embodiment shown in FIG. 5, and the movement of the parallel plates results only in a change of capacitance between the plates, rather than an electrical connection between them.

The deformable plate 1300 may be actuated electrostatically by an adjacent electrostatic electrode 2300, which may be disposed directly above (or below) the deformable plate 1300, and may be fabricated on the via substrate 2000. The deformable plate 1300 itself may form one plate of a parallel plate capacitor, with the electrostatic electrode 2300 forming the other plate. When a differential voltage is placed on the deformable plate 1300 relative to the adjacent electrostatic electrode 2300, the deformable plate is drawn toward the adjacent electrostatic electrode 2300. The action raises (or lowers) the separation limiting standoff 1100 into a position where it contacts the contact points 2112 and 2122, thereby capacitively closing an electrical circuit. Although the embodiment illustrated in FIG. 5 shows the plate formed on the lower substrate and the vias and contacts formed on the upper substrate, it should be understood that the designation “upper” and “lower” is arbitrary. The deformable plate may be formed on either the upper substrate or lower substrate, and the vias and contacts formed on the other substrate. However, for the purposes of the description which follows, the embodiment shown in FIG. 1 is presented as an example, wherein the plate is formed on the lower substrate and is pulled upward by the adjacent electrode formed on the upper substrate.

The MEMS electrostatic switch device 100 with a separation limiting standoff 1100 may be fabricated as follows. Beginning with the plate substrate 1000, an insulating layer of dielectric material 1020, such as SiO₂ may be grown or deposited on the silicon surfaces. Alternatively, the SiO₂ layer may exist as the insulating layer on a silicon-on-insulator (SOI) substrate 1000. The dielectric layer 1020 may then be etched away beneath and around the deformable plate 1300, using a hydrofluoric acid liquid etchant, for example. The liquid etch may remove the silicon dioxide dielectric layer 1020 in all areas where the deformable plate 1300 is to be formed. The liquid etch may be timed, to avoid etching areas that are required to affix the spring beams of the deformable plate 1300, which will be formed later, to the handle layer 1030. Additional details as to the dry and liquid etching procedure used in this method may be found in U.S. patent application Ser. No. 11/359,558 (Attorney Docket No. IMT-SOI Release), filed Feb. 23, 2006 and incorporated by reference in its entirety.

The next step may be the formation of the dielectric pads 1150 and dielectric standoffs 1160 as depicted in FIG. 5. Pad structures 1150 may form an electrical isolation barrier between the standoff 1160 and the deformable plate 1300, functioning as was described above. The deformable plate 1300 and adjacent actuation electrode 2300 form the two plates of a parallel plate capacitor, such that a force exists between the plates when a differential voltage is applied to them, drawing the deformable plate 1300 towards the adjacent electrostatic electrode 2300.

The dielectric pad 1150 may be silicon dioxide, which may be sputter-deposited or thermally grown over the surface of the device layer 1010 of the SOI plate substrate 1000. The silicon dioxide layer may be deposited to a depth of, for example, about 300 nm. The 300 nm layer of silicon dioxide may then be covered with photoresist which is then patterned. The silicon dioxide layer is then etched to form structure 1150. The photoresist is then removed from the surface of the device layer 1010 of the SOI plate substrate 1000. Because the photoresist patterning techniques are well known in the art, they are not explicitly depicted or described in further detail.

Finally, a material is deposited and patterned to form the separation limiting standoff 1160. The material may be any mechanically competent material such as silicon nitride or photoresist. Since the pad layer is dielectric, metal may also be used for the separation limiting standoff. The conductive material may actually be a similar multilayer comprising first a thin layer of chromium (Cr) for adhesion to the silicon and/or silicon dioxide surfaces. The Cr layer may be from about 5 nm to about 20 nm in thickness. The Cr layer may be followed by a thicker layer about 300 nm to about 700 nm of gold (Au), as the conductive metallization layer. Preferably, the Cr layer is about 15 nm thick, and the gold layer is about 600 nm thick. Another thin layer of molybdenum may also be used between the chromium and the gold to prevent diffusion of the chromium into the gold, which might otherwise raise the resistivity of the gold. This layer may also participate in the bonding of the substrates.

More generally, the dielectric separation limiting feature may be at least one of silicon dioxide, silicon nitride, polysilicon, amorphous silicon, spin-on glass (SOG), or a spin coated, temperature tolerant polymer layer such as SU8, polyimide, or benzocyclobutene (BCB).

Turning now to the via substrate 2000, another metallization region may be deposited over the substrate 2000, as shown in FIG. 5. This metallization layer may form the bond ring 2400 as well as adjacent electrostatic electrode 2300. The metallization region may define the second plate 2300 of the parallel plate capacitor of the switch. In one exemplary embodiment, the metallization layer may actually be a multilayer of Cr/Au, the same multilayer as was used for the metallization layer 1400 on the plate substrate 1000 of the dual substrate electrostatic MEMS plate switch 100. The metallization multilayer may have similar thicknesses and may be deposited using a similar process as that used to deposit metallization layer 1400 on substrate 1000. The metallization layer may also serve as a seed layer for the deposition of a metal solder bonding material, as described in the incorporated '798 patent. Layer 2200 may be a native insulating layer of SiO₂ that forms around the silicon substrate 2000. Two more external (to the switch) electrical pads 2115 and 2125 may be connected to through substrate vias 2110 and 2120 (TSV) may provide electrical access to the two electrical nodes 2112 and 2122 within the device 100. Layer 2200 may be a native insulating layer of SiO₂ that forms around the silicon substrate 2000.

Each of the Cr and Au layers may be sputter-deposited using, for example, an ion beam deposition chamber (IBD). The conductive material may be deposited in the region corresponding to the shunt bar 1100, and also the regions which will correspond to the bond line 1400 between the plate substrate 1000 and the via substrate 2000 of the dual substrate electrostatic MEMS plate switch 100. This bond line area 1400 of metallization will form, along with a layer of indium, a seal which will hermetically seal the plate substrate 1000 with the via substrate 2000.

To form the switch, SOI substrate 1000 is pressed against substrate 2000 and the substrates are bonded together in a wafer bonding chamber for example. The adhesive may be a thermocompression bond, a metal alloy bond, or a glass frit bond for example. At bonding, the substrate-to-substrate separation is determined by a standoff 2400 in the bondline, and this separation is approximately D1 as shown in the Figure.

The deformable plate 1300 on substrate 1000 and adjacent actuation electrode 2300 on substrate 2000 may form the two plates of a parallel plate capacitor, such that a force exists between the plates when a differential voltage is applied to them, drawing the deformable plate 1300 towards the adjacent actuation electrode 2300.

A differential voltage may be applied to the deformable plate 1300 and the second plate through another set of TSVs (not shown in FIG. 5). Upon application of a differential voltage between the first plate 1300 and the second plate 2300, the two plates will be drawn together, but their separation limited by the standoff 1100. This minimum separation is defined by the standoff 1100 to be about D2. As before, D2 is about 66% of D1.

At these small separations between the conductors, an RF signal delivered to electrical node 2112 may be capacitively coupled to the other node 2122. Accordingly, there may be no electrical connection between the first plate 1300 and the second plate 2300 or between nodes 2112 and 2122. The actuation of the electrodes 1300 and 2300 may therefore increase the capacitance of the switch, thereby “closing” a capacitive switch, delivering a signal from one electrical node 2112 to the other 2122.

In another embodiment, another dielectric material may be placed on one or the other of both conductive surfaces 1300 and 2300. The thickness of this dielectric layer may be less than the height of the separation limiting standoff 1100. The purpose of the additional dielectric material is to increase the capacitance of the switch due to the difference in dielectric constant between the dielectric material and gas or vacuum. In this embodiment, the separation limiting standoff would reduce the contact area of the plates and thus reduce the charging or stiction.

In this embodiment, the additional dielectric material may again be an oxide such as silicon dioxide, or it may be a spun on or deposited glass, photoresist or ceramic.

The total thickness of the separation limiting feature may be on the order of tens to hundreds of nanometers, and may depend on the geometry of the plates, for example, and the tolerances of the manufacturing processes. The thickness of the additional dielectric material may be on the order of tens of microns, may again, depend on the details of the application.

While various details have been described in conjunction with the exemplary implementations outlined above, various alternatives, modifications, variations, improvements, and/or substantial equivalents, whether known or that are or may be presently unforeseen, may become apparent upon reviewing the foregoing disclosure.

What is claimed is:

1. A device comprising:
a first surface separated from a second surface by an initial distance D1, wherein at least one of the first surface and the second surface further comprises one or more separation limiting standoffs of height D2, wherein the one or more separation limiting standoffs limits a gap between the surfaces to the distance D2, wherein D2<D1, when an actuation is applied.

2. The device of claim 1, wherein D2 is about 66% of D1.

3. The device of claim 1, wherein the device is at least one of an actuator, a switch and a sensor.

4. The device of claim 1, wherein the actuation is at least one of electrostatic, magnetostatic, electromagnetic or piezoelectric.

5. The device of claim 1, wherein the device is a capacitive plate switch, which forms a closed, capacitive connection when the two plates are separated by the distance D2 and forms an open connection when separated by the distance D1, for an RF signal at or above an operating frequency.

6. The device of claim 5, wherein the operating frequency is at least 1 MHz.

7. The device of claim 1, wherein the one or more separation limiting standoffs is a feature in the shape of at least one of a post, a bump, a sphere, a pyramid, a trapezoid.

8. The device of claim 1, wherein the one or more separation limiting standoffs is one in a plurality of raised features.

9. The device of claim 1, wherein the one or more separation limiting standoffs are disposed near or at the periphery of the surfaces.

10. The device of claim 1, wherein the one or more separation limiting standoffs comprise a dielectric substance chosen from the group consisting of silicon dioxide, silicon nitride, polysilicon, amorphous silicon, spin-on glass (SOG), or a spin coated, temperature tolerant polymer layer such as SU8, polyimide, or benzocyclobutene (BCB).

11. The device of claim 1, wherein the device is a MEMS electrostatic plate switch, having two substantially parallel plates.

12. The device of claim 11, wherein the two plates move toward one another upon application of a differential voltage between them.

13. The device of claim 12, wherein the two substantially parallel plates act to open and close a capacitive switch, by changing a capacitance between them as a result of their movement upon application of the differential voltage.

14. The device of claim 13, wherein the two plates are formed on two difference subtrates.

15. The device of claim 14, wherein at least one of the substrates is an SOI wafer.

16. The device of claim 15, wherein the movement of the plates is constrained by the separation limiting standoff to a value of closest approach equalling D2.

17. The device of claim 16, wherein the separation limiting standoff comprises an insulating pad and a mechanically competent feature.

18. The device of claim 17, wherein the insulating pad comprises at least one of a metal oxide, a semiconductor oxide, a photoresist, a glass or a ceramic.

19. The device of claim 17, wherein the mechanically competent feature comprises at least one of a metal, a metal oxide, a metal alloy, or an insulating material.

20. The device of claim 18, wherein the insulating pad comprises silicon dioxide.
